(19) United States
(12) Patent Application Publication
(10) Pub. No.: US 2010/0231498 A1
(43) Pub. Date: Sep. 16, 2010

(54) IMAGE DISPLAY VIA MULTIPLE LIGHT GUIDE SECTIONS

(75) Inventors: Timothy Andrew Large, Bellevue, WA (US); Adrian Travis, Seattle, WA (US); Neil Emerton, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/404,153

(22) Filed: Mar. 13, 2009

(51) Int. Cl. G09G 3/36; F21V 8/00

(52) U.S. Cl. 345/102; 362/621

(57) ABSTRACT

Various embodiments related to a multi-section light guide and computing devices comprising a plurality of wedge light guides are disclosed. For example, one disclosed embodiment comprises a multi-section light guide having a monolithic wedge-shaped body comprising a plurality of logical light guide sections. Each logical light guides section is configured to direct light via total internal reflection between a first light input/output interface located at a first end of the logical light guide section and a second light input/output interface located at a major face of the logical light guide section.

### BACKGROUND

Light guides are wave guides configured to guide visible light between two interfaces via total internal reflection. One type of light guide comprises a wedge-like structure configured to direct light between an interface located at one side edge of the wedge and another interface located at a major face of the wedge. Light that enters the wedge at the side edge interface is internally reflected until reaching a critical angle relative to the interface at the major surface. This allows a relatively small image projected at the side edge interface to be displayed as a relatively larger image on the major face interface of the wedge.

The thickness of an optical wedge may be a function of the size of the image desired at the major face interface of the wedge. As wedge size and thickness increases, manufacturing and materials costs also may increase.

### SUMMARY

Various embodiments are disclosed herein that relate to the use of multiple light guide sections to deliver an image. For example, one disclosed embodiment provides a multi-section light guide. The multi-section light guide comprises a monolithic wedge-shaped body comprising a plurality of logical light guide sections, each logical light guide section being configured to direct light via total internal reflection between a first light input/output interface located at a first end of the logical light guide section and a second light input/output interface located at a major face of the logical light guide section. Further, each logical light guide section comprises a reflector formed in a second end of the logical light guide section, the reflector forming a folded optical path within each logical light guide section.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an embodiment of a multi-section light guide.

FIG. 2 shows a top view of the embodiment of FIG. 1.

FIG. 3 shows a top view of another embodiment of a multi-section light guide.

FIG. 4 shows a top view of another embodiment of a multi-section light guide.

FIG. 5 shows a sectional view of a multi-section light guide comprising an optical cladding.

FIG. 6 shows a block diagram of an embodiment of a computing device having a backlight system comprising an embodiment of a multi-section light guide.

FIG. 7 shows another embodiment of a multi-section light guide in the form of two wedge light guides in a side-by-side arrangement.

FIG. 8 shows an embodiment of two light guides in a stacked arrangement.

FIG. 9 shows an embodiment of a personal computing device with an adaptive a keyboard comprising an embodiment of a multi-section light guide.

### DETAILED DESCRIPTION

As described above, wedge light guides may allow the production of a relatively large image at a major face interface of the wedge light guide from a relatively small image introduced at an edge interface of the light guide. Such wave guides allow an optical path length to be increased via the use of total internal reflection within the wave guide. More specifically, light introduced at the edge interface may reflect back and forth between the internal faces of the wedge as the light travels along the length of the wedge until reaching the critical angle relative to the face of the wedge. The resulting increase in optical path length may allow the display of relatively large images even with relatively tight spatial constraints.

However, it will be appreciated that the size and thickness of an optical wedge increases as the desired area of the major face interface of a light wedge increases. Due to the increases in thickness, the materials costs for an optical wedge may increase significantly with wedge size.

Further, other system components may become more expensive as the size of an optical wedge increases. For example, an optical touch-sensitive display device may utilize an image sensor, such as a camera, located at the edge interface of an optical wedge to detect objects placed over the major surface interface of the optical wedge. As size of the major surface interface of the optical wedge increases, a higher resolution, and therefore more expensive, image sensor may be employed to maintain a desired level of touch sensitivity.

To avoid such increased materials and component costs, various embodiments of multi-section light guides are disclosed herein that enable the use of a thinner wedge to deliver an image relative to a single wedge light guide. The term “multi-section light guide” and variants thereof as used herein denote a wedge light guide with multiple, separate logical light guide segments, wherein the segments may be part of a single, larger monolithic body. Further, various embodiments of computing devices and peripheral devices are disclosed herein that utilize multi-section light guides and/or multiple physically separate light guides to transport light between a display and other optical components.

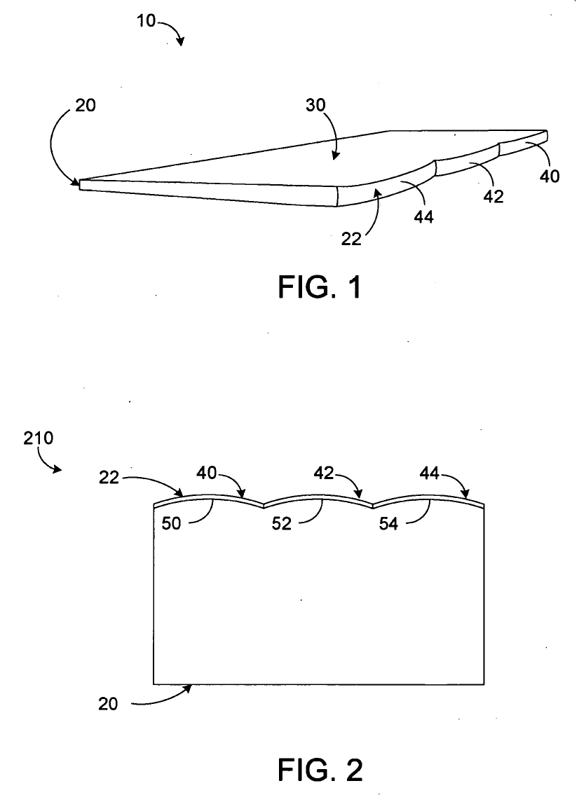

FIG. 1 shows an example embodiment of a multi-section light guide 10. The multi-section light guide 10 comprises a monolithic wedge-shaped body with a plurality of logical light guides sections 40, 42, and 44 defined therein. While the embodiment of FIG. 1 shows three logical light guide sections, it will be understood that, in other embodiments, a multi-section light guide may comprise either fewer or more logical light guide sections.

Each logical light guide section 40, 42, 44 is configured to direct light of a desired range of wavelengths via total internal reflection between a first light input/output interface located at a first end (for example, along edge 20) of the wedge light guide and a second light input/output interface located at a major face 30 of the wedge light guide. This major face 30 also may be referred to as display surface 30. Each logical light guide section may be configured such that the second light input/output interface of that logical light guide is arranged edge-to-edge with the second light input/output interfaces of adjacent logical light guide sections. In this manner, the display surface 30 forms a unitary continuous area of the major face of the monolithic wedge-shaped body, allowing the display of a single contiguous image via the plurality of logical light guide sections.

In some embodiments, each logical light guide section may be configured to direct light in only one latitudinal direction (i.e. parallel to the major face between the first and second light input/output interfaces). Such an embodiment is shown, for example, in FIG. 8. In such an embodiment, the light guide comprises an angled bottom surface (i.e. opposite the second light input/output interface surface) that changes the angle at which the light within the light guide is incident on the internal surfaces of the light guide. This change in angle allows light to escape the light guide. In these embodiments, no light introduced into the edge interface with an angle less than the critical angle leaves the light guide in the region prior to the change in angle of the bottom surface. This results in the total size of the light guide potentially being relatively large relative to the area of the second input/output interface surface.

In other embodiments, each logical light guide section may comprise a reflector formed in an end of the logical light guide section that is configured to create a folded optical path within the logical light guide. The use of such a reflector may allow for a more compact wedge design, as the reflector may be used to change the angle of light propagating within the light guide. This may therefore allow a reduction in size, or omission of, the region of the light guide in which the top and bottom major surfaces are parallel. For example, in the embodiment of FIGS. 1-2, each logical light guide section 40, 42, and 44 comprises a reflector 50, 52, 54 formed in a second end (i.e. along edge 22, opposite light input/output interface 20) of the logical light guide sections. The reflectors 50, 52, 54 each may be a spherical reflector, or may have any other suitable configuration.

A multi-section light guide may have any suitable construction. For example, in one embodiment, each light guide section may be formed from a single, monolithic sheet of extruded material. In such an embodiment, the reflector may be formed by machining a side of the sheet, followed by applying various layers of materials to the machined side of the sheet to improve the reflectivity of the reflector.

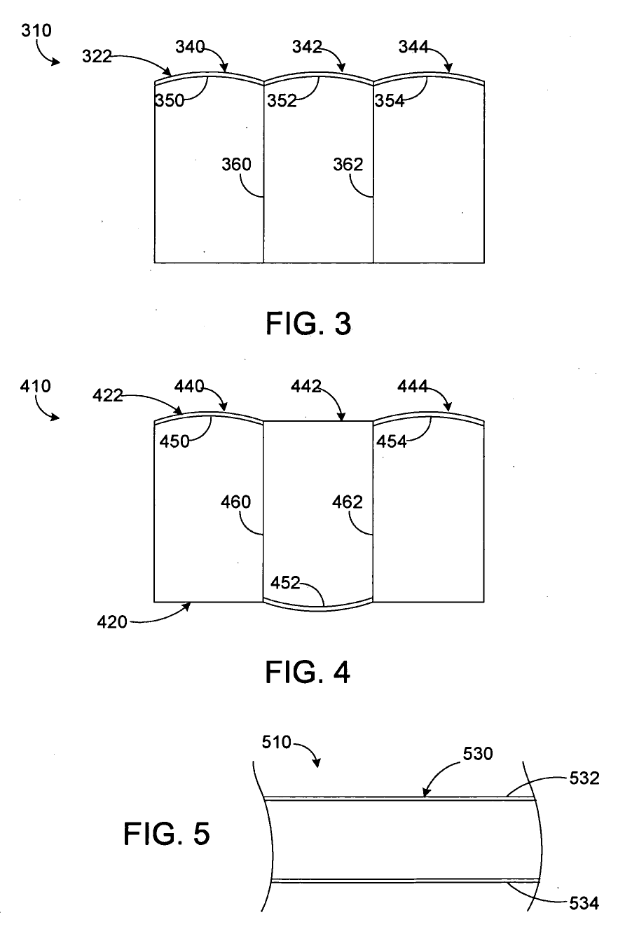

In other embodiments, each logical light guide section may be separately formed, and then fused or otherwise joined to other sections to create the multi-section light guide. FIG. 3 shows a schematic view of a multi-section light guide 310 comprising three logical light guide sections 340, 342, 344 separated by joints 360, 362. Each logical light guide section 340, 342, 344 comprises a reflector, shown respectively at 350, 352, 354, formed in an edge 322 of the multi-section light guide. It will be understood that such joint may in fact be optically invisible when the sections are actually joined together, and that the joints are shown in FIG. 3 for the purpose of illustration.

In the embodiments of FIGS. 1-3, the logical light guide sections are arranged such that the reflectors are located in a same edge 22 of the multi-section light guide. FIG. 4 shows another embodiment of a multi-section light guide 410 in which the logical light guide sections 440, 442, 444 are arranged such that the reflectors 450 and 454 are located on one edge 422, while the reflector 452 is located on an opposite edge 420 of the multi-section light guide. In the depicted embodiment, the logical light guide sections 440, 442, 444 formed by separate sections joined together at joints 460, 462 (again, which may be invisible but are shown for the purpose of illustration).

In some embodiments, various materials and/or treatments may be applied to the multi-section light guide to achieve desired optical properties. For example, in some embodiments, a cladding may be applied to the outer surfaces of a multi-section light guide to tune the internal reflection characteristics of the light guide. FIG. 5 shows a sectional view of an optical light guide 510, taken along a direction perpendicular to the optical path between the edge light input/output interface and the reflector. The depicted light guide comprises a layer of cladding 532 on an upper surface of the light guide (relative to the orientation of the light guide shown in FIG. 5), and also a layer of cladding 534 on a lower surface. In other embodiments, a layer of cladding may be used on only one of these two surfaces. In yet other embodiments, a multi-section light guide may comprise one or more additional integrated optical structures, including but not limited to a microlens array, a lenticular lens array, a Fresnel lens structure, an anti-reflective coating, a diffuser screen, etc.

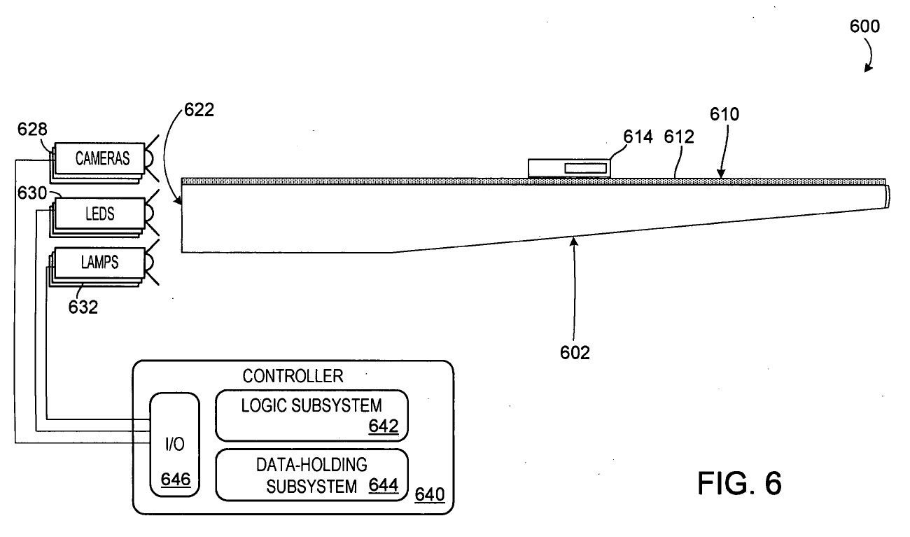

As mentioned above, a multi-section light guide may be used to provide light (e.g. backlighting or a projected image) to a surface computing device. FIG. 6 schematically shows a computing device 600 in the form of a surface computer comprising multi-section light guide 610. The computing device 600 comprises a display surface 610, and a liquid crystal display (LCD) panel 612 configured to provide an image to the display surface. The LCD panel 612 may have any suitable size and aspect ratio. For example, some embodiments, the LCD panel 612 has a screen diagonal of 32″, 37″, 42″, or 46″ and comprises a 16:9 aspect ratio.

The computing device 600 further comprises a backlight system comprising a multi-section light guide 602. The backlight system is configured to provide light to the LCD panel 612. The backlight system comprises one or more light sources for each logical light guide section, such as the depicted lamps 632. The depicted embodiment comprises three lamps 632, such that one lamp introduces light into each logical light guide section for delivery of backlight to the LCD panel. It will be understood that any other suitable light source other than lamps may be used, including but not limited to light emitting diode arrays, etc. Further, it will be understood that, in other embodiments, the backlight system may comprise a plurality of individual light guides arranged in a side-by-side manner, instead of or in addition to the multi-section light guide 610. It will also be understood that the delivery of backlighting may be considered “delivery of an image” and the like as used herein.

The use of a multi-section light guide such as the embodiments described above, or multiple physical light guides, may allow the use of a substantially thinner light guide than if a single light guide were used to backlight an LCD panel of the same size. The following tables illustrate the differences in thickness of a light guide that uses three logical light guide sections to backlight LCD panels of the sizes shown above compared to the use of a light guide with a single logical light guide section. First, TABLE 1 illustrates the maximum thicknesses of light guides in the case of a single physical light guide comprising a single logical light guide section.

TABLE 1

| | Light | Light | |
|---|---|---|---|
| LCD | Guide | Guide | Light Guide |
| Diagonal | Height | Width | Thickness |
| (in) | (mm) | (mm) | (mm, max) |
| 32 | 398 | 771 | 19 |
| 37 | 461 | 884 | 22 |
| 42 | 523 | 997 | 25 |
| 46 | 573 | 1087 | 27 |

Next, TABLE 2 illustrates the thicknesses of light guides for each of the above-referenced LCD panel sizes where the three-logical-section configuration of FIG. 1 is utilized for the multi-section light guide, such as multi-section light guide 10 of FIGS. 1-2.

TABLE 2

| | Light | Light | |
|---|---|---|---|
| LCD | Guide | Guide | Light Guide |
| Diagonal | Height | Width | Thickness |
| (in) | (mm) | (mm) | (mm, max) |
| 32 | 466 | 236 | 12 |
| 37 | 531 | 273 | 13 |
| 42 | 596 | 310 | 15 |
| 46 | 649 | 339 | 16 |

Therefore, as can be seen in these tables, the use of a light guide with multiple logical sections allows the use of a thinner, and therefore less expensive, light guide than a light guide of similar size but with a single section.

The computing device 600 further comprises a vision-based touch-detection system that comprises a camera 628 and an infrared light source, such as infrared light emitting diode 630, for each logical light guide section. The infrared light emitting diodes 630 are configured to introduce infrared light into each logical light guide section. Any objects placed on the display surface 610, such as object 614, will reflect infrared light from the light emitting diodes 630. This light may then be detected via cameras 628 to thereby allow the vision-based detection of objects touching the display surface 610. The depicted embodiment is illustrated as having three cameras 628 and three infrared light emitting diodes 630, such that each logical light guide has one camera 628 and one light emitting diode 630 associated therewith. However, it will be understood that each logical light guide may have any suitable number of infrared light sources 628 and cameras 630.

The use of three logical light guide sections to illuminate a 16:9 LCD panel compared to the use of a single physical/logical light guide also may offer the advantage that lower resolution cameras may be utilized to detect touch. For example, in some embodiments, a camera resolution of 30 dpi (dots per inch) may be sufficient resolution to detect touch events, including moving touch events, and also some optically readable tags. Before comparing this to an image detected via an optical wedge, it should be noted that, in some embodiments, an optically clad multi-section light guide may have an optical anamorphism that causes an object placed on display surface 610 surface to appear to a camera located at edge 622 to have been reduced in size by a factor of 2:1. As a result, a 16:9 image becomes a 4:3 image as viewed by cameras 628 in such embodiments.

In the case of a single light guide used to illuminate a 46″ LCD panel, a VGA camera with a 640×480 array of pixels would have only 480 lines in a direction of the optical path from interface 622 to display surface 610. This corresponds to a resolution of 12 dpi. Therefore, a higher resolution, more expensive camera would be employed to reach a 30 dpi resolution. On the other hand, where three logical light guides are used, because each camera sees only a portion of the display surface 610, a lower resolution camera may be used. As a specific example, for the case of a 32″ LCD monitor, a resolution greater than 30 dpi may be achieved in the case of a single physical/logical light guide with an XGA camera, while a similar resolution may be achieved with a VGA camera in the case of three logical light guides.

Continuing with FIG. 6, the computing device 600 also comprises a controller 640 configured to control the various components of the computing device 600. The controller in the present embodiment includes a logic subsystem 642, data holding subsystem 644 operatively coupled to the logic subsystem 642 and an input/output port (I/O) system 646.

Logic subsystem 642 may include a logic subsystem 642 configured to execute one or more instructions that are part of one or more programs, routines, objects, components, data structures, or other logical constructs. The logic subsystem 642 may include one or more processors that are configured to execute software instructions. Additionally or alternatively, the logic subsystem 642 may include one or more hardware or firmware logic machines configured to execute hardware or firmware instructions. The logic subsystem 642 may optionally include individual components that are distributed throughout two or more devices, which may be remotely located in some embodiments.

Data-holding subsystem 644 may include one or more components configured to hold data and/or instructions executable by the logic subsystem 642. Data-holding subsystem 644 may include removable media and/or built-in devices, optical memory devices, semiconductor memory devices, magnetic memory devices, etc., and may include memory with one or more of the following characteristics: volatile, nonvolatile, dynamic, static, read/write, read-only, random access, sequential access, location addressable, file addressable, and content addressable. In some embodiments, logic subsystem 642 and data-holding subsystem 644 may be integrated into one or more common devices, such as an application specific integrated circuit or a system on a chip.

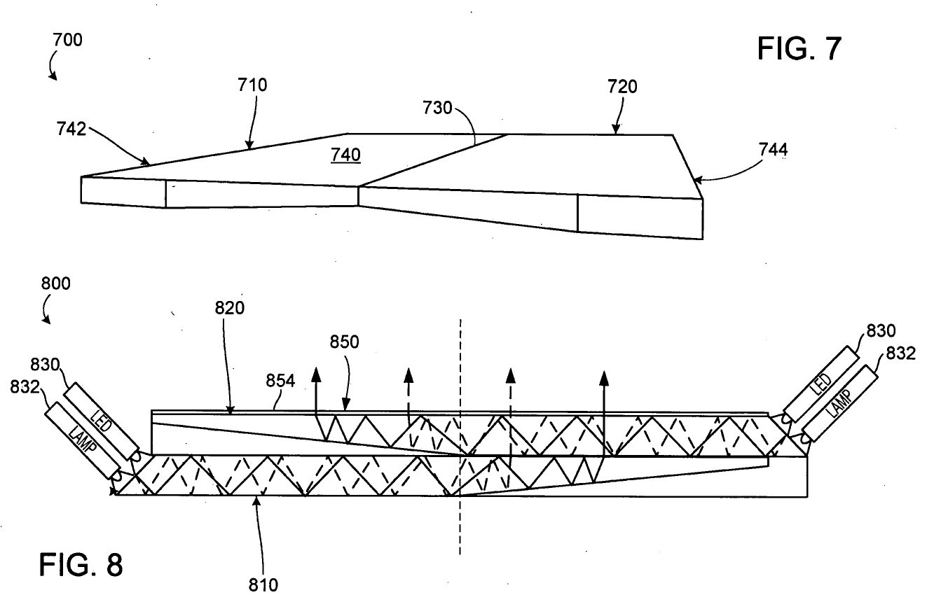

FIGS. 7 and 8 show examples of other embodiments of multiple light-guide configurations for providing an image to a display surface. First referring to FIG. 7, two light guides 710 and 720 are shown in another side-by-side arrangement 700 such that the light guides meet along line 730 to form a unitary display surface 740.

Each wedge light guide 710, 720 may include one or more logical light guide sections. The first wedge light guide 710 comprises one or more input/output interfaces along edge 742, and the second wedge light guide 720 comprises one or more input/output interface along edge 744. In this manner, light sources, cameras, etc. for each light guide 710, 720 will be located on opposites of the arrangement 700. It will be understood that arrangement 700 may be formed either from a single, monolithic piece of material, or from individual light guides that are fused or otherwise joined together at edge 730.

Turning now to FIG. 8, the two example wedge light guides 810 and 820 are shown in a stacked arrangement 800. The upper portion of wedge light guide 820 comprises a display surface 850 configured to provide backlighting to an LCD panel 854. In the embodiment of FIG. 8, major faces of wedge light guides 810 and 820 do not join to form a single unitary continuous area, as described above with reference to FIG. 7. Instead, light from light guide 810 provides light to a right-side portion of LCD panel 854 (in the orientation of FIG. 8), and light from light guide 820 provides light to a left-side portion of LCD panel 854.

FIG. 8 also shows infrared LEDs 830 and visible lamps 832 configured to provide infrared light and visible light, as described above with reference to FIG. 6.

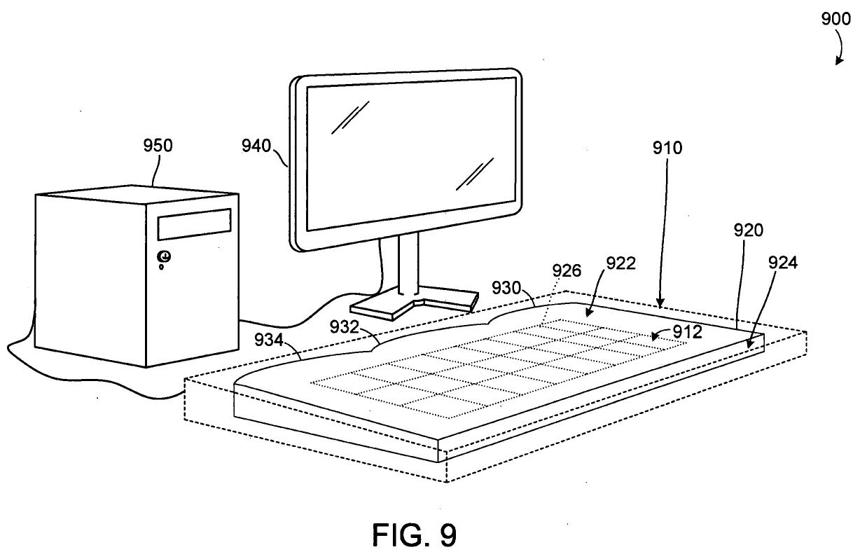

FIG. 9 shows another use environment for a multi-section light guide, in the form of an adaptive keyboard 910 for a personal computing device 900. The adaptive keyboard 910 may be a “computing device” as the term is used herein. The multi-section light guide is depicted at 920, and is configured to provide individual images to one or more keys 912 of the adaptive keyboard 910. The personal computing device may also include a monitor 940 and personal computer 950.

The adaptive keyboard 910 may include an LCD panel (not shown) positioned between the multi-section light guide 920 and the keys 912 of the keyboard. Further, the adaptive keyboard 910 may include a collimated backlighting system (not shown) configured to provide parallel light to the LCD panel. In this manner, the LCD panel may be controlled to display desired images on each individual key of the keyboard, and may allow the characters/symbols/images/etc. displayed on each keyboard key to be modified for different use environments, such as different character sets, different software programs, etc. The depicted multi-section light guide 920 has three logical light guide sections 930, 932 and 934, but it will be understood that the multi-section light guide 920 may have any other suitable number of logical light guide sections.

While disclosed herein in the context of specific example embodiments, it will be appreciated that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. A multi-section light guide, comprising:
a monolithic wedge-shaped body comprising a plurality of logical light guide sections, each logical light guide section being configured to direct light via total internal reflection between a first light input/output interface located at a first end of the logical light guide section and a second light input/output interface located at a major face of the logical light guide section, each logical light guide section comprising a reflector formed in a second end of the logical light guide section, the reflector forming a folded optical path within each logical light guide section.

2. The multi-section light guide of claim 1, further comprising a cladding configured to control an angle of total internal reflection of light within the light guide.

3. The multi-section light guide of claim 1, wherein the plurality of logical light guide sections are further configured to direct light in the infrared spectrum between the first light input/output interface and the second light input/output interface.

4. The multi-section light guide of claim 1, wherein the plurality of logical light guides are arranged in a side-by-side manner such that the reflectors of all logical light guide sections are located along a single side of the monolithic wedge-shaped body.

5. The multi-section light guide of claim 5, wherein the reflector is a spherical reflector.

6. The multi-section light guide of claim 5, wherein the second light input/output interfaces of the plurality of logical light guides comprise a unitary continuous area of a face of the monolithic wedge-shaped body.

7. The multi-section light guide of claim 1, wherein the monolithic wedge-shaped body comprises three logical light guides.

8. A computing device, comprising:
a display surface;
a liquid crystal display panel configured to provide an image to the display surface;
a controller configured to control an image displayed on the display surface;
a backlight system configured to provide light to the liquid display panel, the backlight system comprising a plurality of wedge light guides each configured to provide backlighting to a portion of the liquid crystal display panel, the backlight system also comprising one or more light sources configured to provide light to the plurality of light guides;
one or more image sensors configured to acquire an image of a backside of the display surface via light transported to the image sensors from the display surface through the plurality of wedge light guides; and
an infrared illuminant configured to provide infrared light to the plurality of wedge light guides.

9. The computing device of claim 8, wherein the plurality of wedge light guides comprises two or more logical light guides defined within a single monolithic body.

10. The computing device of claim 8, wherein each wedge light guide of the plurality of wedge light guides comprises a separate body.

11. The computing device of claim 10, wherein two or more of the wedge light guides are arranged in a stacked arrangement.

12. The computing device of claim 10, wherein two or more of the wedge light guides are arranged in a side-by-side arrangement.

13. A computing device, comprising:
a display surface;
a liquid crystal display panel configured to provide an image to the display surface;
a controller configured to control the liquid crystal display;
a backlight system configured to provide light to the liquid display panel, the backlight system comprising a monolithic wedge-shaped body comprising a plurality of logical light guide sections, each logical light guide section being configured to direct light via total internal reflection between a first light input/output interface located at a first end of the logical light guide section and a second light input/output interface located at a major face of the logical light guide section, the second light input/output interfaces of the plurality of logical light guides comprising a unitary continuous area of a face of the monolithic wedge-shaped body, each logical light guide section further comprising a reflector formed in a second end of the logical light guide section to form a folded optical path within each logical light guide section; the backlight system also comprising one or more light sources configured to provide light to the plurality of logical light guides;
an infrared illuminant system configured to provide infrared light to the first light input/output interface of each logical light guide; and
a plurality of image sensors configured to acquire an image of a backside of the display surface, each logical light guide having one or more associated image sensors.

14. The computing device of claim 13, wherein the LCD further comprises a 16:9 aspect ratio, and where each logical light guide is configured to focus a 4:3 aspect ratio image on the first light input/output interface.

15. The computing device of claim 13, wherein the monolithic wedge-shaped body comprises three logical light guides, and wherein one image sensor is associated with each logical light guide.

16. The computing device of claim 13, further comprising a cladding configured to control an angle of total internal reflection of light within the light guide.

17. The computing device of claim 13, wherein the plurality of logical light guide sections are further configured to direct light in the infrared spectrum between the first light input/output interface and the second light input/output interface.

18. The computing device of claim 13, wherein the plurality of image sensors comprises a photo-detector configured to detect a scanning beam of collimated light.

19. The computing device of claim 13, wherein the plurality of image sensors comprises a complementary metal-oxide-semiconductor (CMOS) image sensor.

20. The computing device of claim 13, wherein the plurality of image sensors comprises a charge coupled device.
